(19) United States
(12) Patent Application Publication
(10) Pub. No.: US 2021/0213650 A1
(43) Pub. Date: Jul. 15, 2021

(54) MOLD HAVING NEAR-SURFACE CHANNELS FORMED THEREIN AND METHOD OF MAKING THE SAME

(71) Applicant: GM GLOBAL TECHNOLOGY OPERATIONS LLC, Detroit, MI (US)

(72) Inventors: Anthony M. Coppola, Rochester Hills, MI (US); Brennon L. White, Novi, MI (US)

(73) Assignee: GM GLOBAL TECHNOLOGY OPERATIONS LLC, Detroit, MI (US)

(21) Appl. No.: 16/743,400

(22) Filed: Jan. 15, 2020

(51) Int. Cl. B29C 33/38; B29C 33/00; B29C 33/56; B29C 33/42; B33Y 80/00

(52) U.S. Cl. CPC B29C 33/3842; B29C 33/0022; B29C 2033/385; B29C 33/42; B33Y 80/00; B29C 33/56

(57) ABSTRACT

A method of fabricating a mold for producing a part includes applying a network of sacrificial components onto a first surface of a mold base, wherein the sacrificial components are made of a sacrificial material, covering the network of sacrificial components and the first surface with a layer of a covering material, and removing the sacrificial material to produce a network of channels within the layer of covering material. The network of sacrificial components may be formed by additive manufacturing or by mechanical placement of a preformed network of sacrificial components.

### INTRODUCTION

This disclosure relates to molds having near-surface channels formed therein, and methods of fabricating such molds.

Composite- or polymer-based molds are often used to form large composite parts, such as covers or panels for automobiles. However, typical molds are made of materials having low thermal conductivity, making it difficult to mold composite parts that require heat to cure. Such composite parts often have to be removed from the mold and cured in a separate curing environment (e.g., an enclosed, ventilated and heated curing chamber), or the entire mold and composite part together have to be subjected to the curing environment (which may require moving the mold-and-part combination into the curing environment).

### SUMMARY

According to one embodiment, a method of fabricating a mold for producing a part includes applying a network of sacrificial components onto a first surface of a mold base, wherein the sacrificial components are made of a sacrificial material, covering the network of sacrificial components and the first surface with a layer of a covering material, and removing the sacrificial material to produce a network of channels within the layer of the covering material. The method may further include curing the layer of the covering material, and the removing step may be performed by deflagration of the sacrificial material. Alternatively, the removing step may be performed by one of melting, dissolution and vaporization of the sacrificial material. The mold base may be made of a base material that is different from the covering material. The applying step may be performed by one of building up the network of sacrificial components on the first surface of the mold base by additive manufacturing, and placing the network of sacrificial components onto the first surface of the mold base wherein the network of sacrificial components is preformed.

The method may further include forming a layer of a coating material on a base portion made of a base material to form the mold base, wherein the layer of coating material has a free surface serving as the first surface of the mold base. The covering material and the coating material may be the same, and the method may further include curing the layer of the coating material. The free surface may include a network of furrows formed therein, wherein the network of sacrificial components is applied within the network of furrows.

According to one embodiment, a method of fabricating a mold includes: (i) forming a coating layer made of a coating material on a base portion made of a base material to form a mold base, wherein the coating layer has an interfacial surface in conformal contact with the base portion and a free surface opposite the interfacial surface; (ii) applying a network of sacrificial components onto the free surface of the coating layer, wherein the sacrificial components are made of a sacrificial material; (iii) covering the network of sacrificial components and the free surface with a covering layer made of a covering material; and (iv) removing the sacrificial material to produce a network of channels within the covering layer. The removing step may be performed by one of deflagration, melting, dissolution and vaporization of the sacrificial material, and the method may include at least one of curing the coating layer and curing the covering layer. The free surface may include a network of furrows formed therein, wherein the network of sacrificial components is applied within the network of furrows. The applying step may be performed by one of building up the network of sacrificial components on the free surface of the coating layer by additive manufacturing, and placing the network of sacrificial components onto the free surface of the coating layer wherein the network of sacrificial components is preformed.

According to one embodiment, a mold for producing a part includes a mold base having a first surface, a layer of a covering material covering the first surface, and a network of channels disposed within the layer of covering material and produced by (i) forming a network of sacrificial components within the layer of covering material corresponding to the network of channels, wherein the sacrificial components are made of a sacrificial material, and then (ii) removing the sacrificial material. The sacrificial material may be removed by deflagration. Alternatively, the sacrificial material may be removed by one of melting, dissolution and vaporization of the sacrificial material. The mold may further include a layer of a coating material interposed between the mold base and the layer of covering material. The network of sacrificial components may be formed by one of additive manufacturing and mechanical placement wherein the network of sacrificial components is preformed.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a flowchart of a method of fabricating a mold in accordance with the disclosure.

FIGS. 2A-2F are schematic sectional elevation views illustrating successive steps in forming a mold in accordance with the disclosure.

FIGS. 3A-3E are schematic sectional elevation views illustrating alternative steps in forming a mold in accordance with the disclosure.

FIGS. 4A-4E are schematic sectional elevation views illustrating further alternative steps in forming a mold in accordance with the disclosure.

FIG. 5 is a schematic sectional top view of a mold in accordance with the disclosure, with part of the covering layer removed to show the network of channels.

FIG. 6 is a schematic sectional elevation view of the mold as viewed along section 6-6 of FIG. 5.

FIG. 7 is a schematic isometric view of a sacrificial component formed within a substrate.

FIG. 8 is a schematic sectional view of the sacrificial component, as viewed along section 8-8 of FIG. 7.

FIG. 9 is a schematic isometric view of the sacrificial component being ignited while still partly disposed within the substrate.

FIG. 10 is a schematic isometric view depicting deflagration of the sacrificial material within the substrate.

FIG. 11 is a schematic isometric view depicting a channel being cleaned after deflagration of the sacrificial component.

FIG. 12 is a schematic sectional view of a branched network of sacrificial components within a substrate, wherein the network includes intersecting filaments.

FIG. 13 is a schematic sectional view of the branched network shown in FIG. 12, while the sacrificial components are being ignited.

FIG. 14 is a schematic sectional view of the branched network shown in FIG. 13, depicting the channel formed after the sacrificial component has been deflagrated.

FIG. 15 is a schematic isometric view of a 3D printer creating a network or preform of sacrificial components.

FIG. 16 is a schematic isometric view of a network or preform of sacrificial components.

FIG. 17 is a schematic front view of the network or preform of FIG. 16 inside a container.

FIG. 18 is a schematic front view of the network or preform of FIG. 16 inside the container, wherein liquid material for forming a protective shell or coating has been poured in the container.

FIG. 19 is a schematic front view of the network or preform of FIG. 16 inside the container, after the liquid material has been removed.

FIG. 20 is a schematic front view of the finished network or preform after curing.

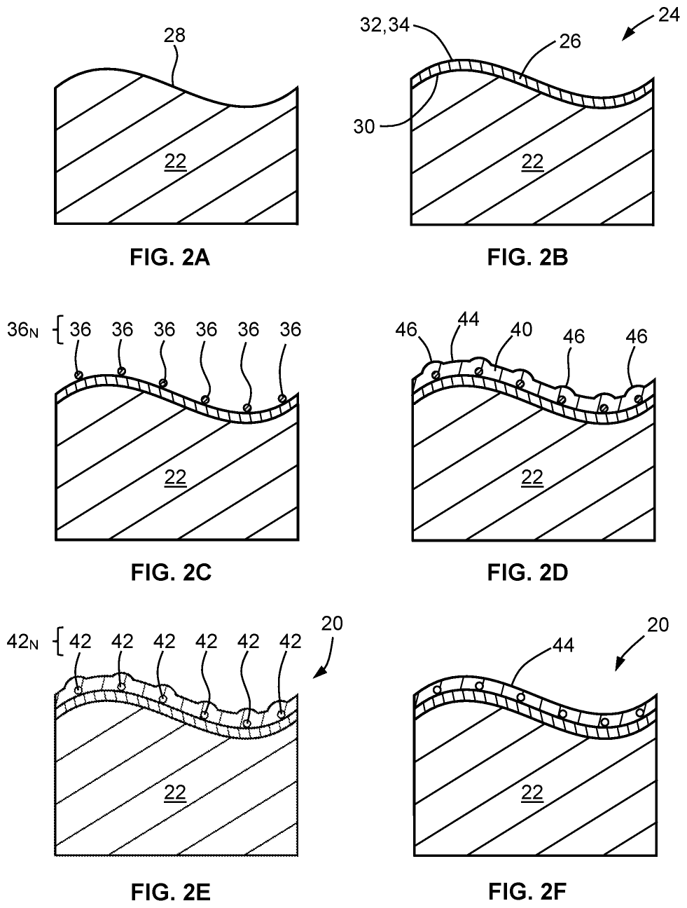

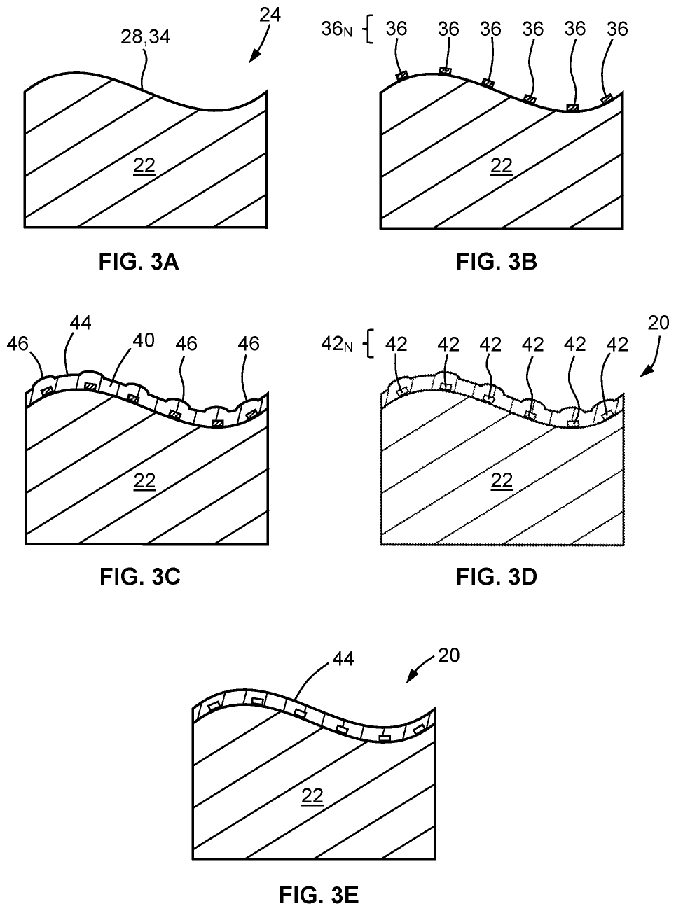

Note that some of the drawings herein are presented in multiple related views, with the related views sharing a common Arabic numeral portion of the figure number and each individual view having its own unique “alphabetic” portion of the figure number. For example, FIGS. 2A through 2F are schematic sectional elevation views illustrating successive steps in forming a mold according to an embodiment of the disclosure; each related view shares the same Arabic numeral (i.e., 2), but each individual view has its own unique “alphabetic” designation (i.e., A through F). When drawings are numbered in this way, reference may be made herein to the Arabic number alone to refer collectively to all the associated “alphabetics”; thus, “FIG. 2” refers to FIGS. 2A through 2F collectively. Likewise, “FIG. 3” refers to FIGS. 3A through 3E collectively, and so forth.

### DETAILED DESCRIPTION

Referring now to the drawings, wherein like numerals indicate like parts in the several views, a mold having near-surface channels formed therein, and methods for making such molds, are shown and described herein.

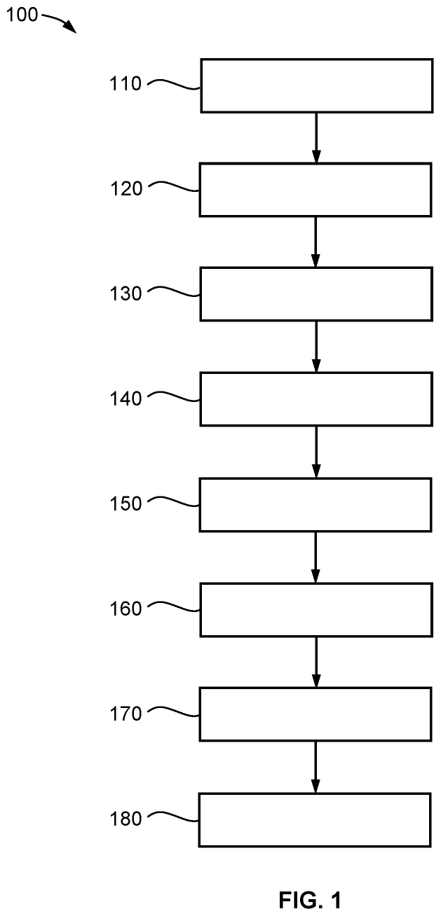

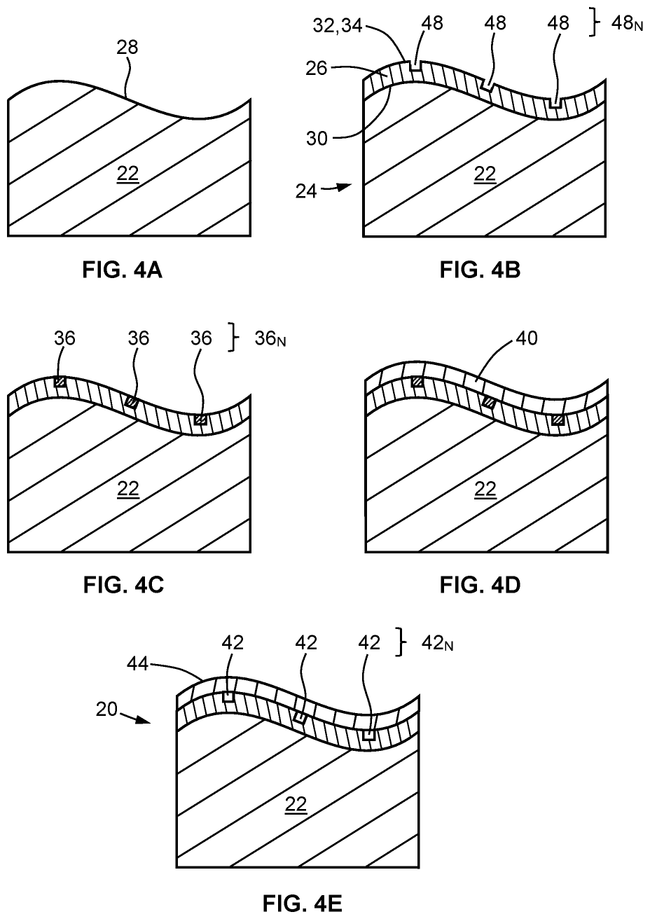

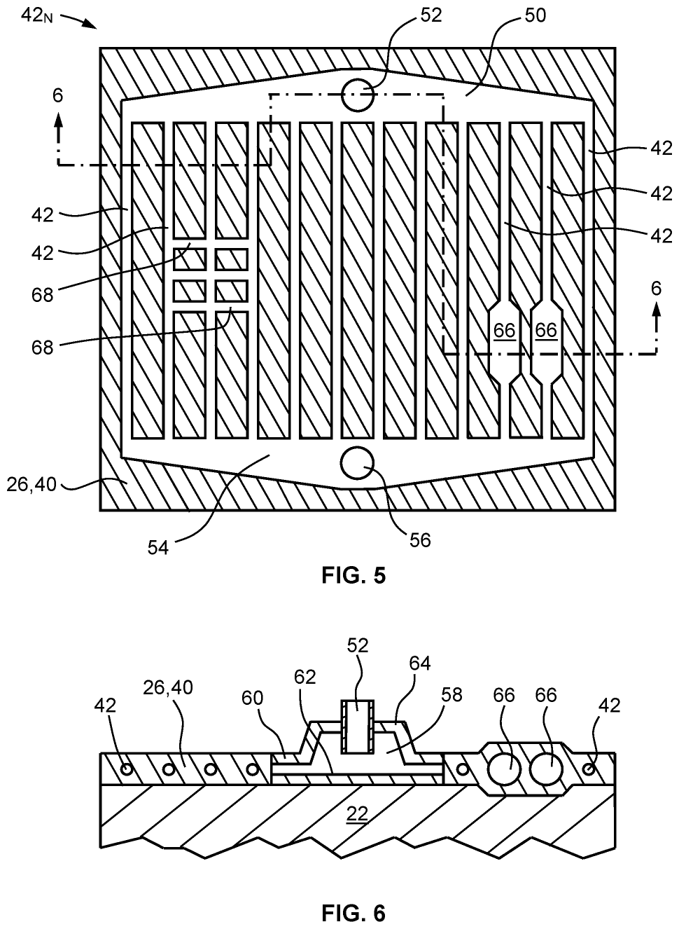

FIG. 1 shows a flowchart of a method 100 of fabricating a mold 20 having near-surface channels 42, and FIGS. 2-4 illustrate three related sequences of steps for producing the mold 20 according to the method 100. At block 110, abase portion 22 of a mold base 24 is formed or provided, in which the base portion 22 is made of a base material such as metal, wood, polymer, etc. The base portion 22 serves to provide an overall shape and structural support for the mold 20, but the base portion 22 does not include the molding surface 44 (described later) with which the molded part interfaces. At block 120, an optional layer 26 of coating material may be formed on a top surface 28 of the base portion 22. The coating material may be a polymer, adhesive or other suitable material which is capable of bonding with the base portion 22 (or being bonded with the base portion 22 via an appropriate bonding agent). For example, the coating material may be a thermoplastic or thermoset polymer. Alternatively, the coating layer 26 may be an applique or the like which may be applied to the top surface 28 of the base portion 22. The coating layer 26 has a bottom or interfacial surface 30 in conformal contact with the top surface 28 of the base portion 22 and a top or free surface 32 serving as a first surface 34 of the mold base 24. (Note that in FIGS. 2 and 4, the mold base 24 comprises the base portion 22 and the coating layer 26, while in FIG. 3 there is no coating layer 26 so the mold base 24 comprises only abase portion 22. Similarly, in FIGS. 2 and 4, the top or free surface 32 of the coating layer 26 serves as the first or top-most surface 34 of the mold base 24, while in FIG. 3 the top surface 28 of the base portion 22 serves as the first or top-most layer 34 of the mold base 24.) At block 130, the optional coating layer 26 may be cured, such as by applying heat or an accelerating agent to the coating layer 26.

At block 140, a network 36_{N} of sacrificial components 36 is applied onto the first surface 34 of the mold base 24, wherein the sacrificial components 36 are made of a sacrificial material. The sacrificial material may be a material that can be used to form the network 36_{N} of sacrificial components 36, and which can also be subsequently removed by deflagration, melting, dissolution or vaporization. For example, the sacrificial material may be a combustible material such as black powder which can be ignited and deflagrated. As another example, the sacrificial material may be a material having a lower melting point than that of any of the other materials used in the mold 20. As a further example, the sacrificial material may be dissolvable (such as by an etchant) or vaporizable (such as by depolymerization).

The sacrificial components 36 may be shaped as elongated members having cross-sections that are circular, rectangular or any other suitable shape. The cross-sectional shape of a sacrificial component 36 may remain constant along its length or it may vary. The “network” 36_{N} of sacrificial components 36 may be a web, collection or grouping of components 36 which are interconnected with each other, as further discussed below.

The step 140 of applying the network 36_{N} of sacrificial components 36 may be performed by various methods. One approach is to build up the network 36_{N} of components 36 on the first surface 34 of the mold base 24 by additive manufacturing (e.g., 3D printing, electroplating, etc.). Another approach is to form the network 36_{N} of components 36 as a preform or web, separate from the mold base 24 (e.g., by 3D printing, compaction, etc.), and then mechanically placing the network/web/preform 36_{N} onto the first surface 34 of the mold base 24 (e.g., by robotic manipulation). This latter approach may optionally include the use of a suitable adhesive or other agent for affixing the preform 36_{N} in place on the first surface 34.

At block 150, the network 36_{N} of sacrificial components 36 and the first surface 34 of the mold base 24 are covered with a layer 40 of a covering material. This may be a material that is different from the coating material, or it may be the same material. For example, the covering material may be a thermoplastic or thermoset polymer. At block 160, the layer 40 of covering material may be cured, such as by the application of heat or an accelerating agent, and at block 170, the sacrificial material is removed to produce a network 42_{N} of channels 42 within the layer 40 of covering material. The removing step 170 may be performed by deflagration, melting, dissolution or vaporization of the sacrificial material. Note that while the base material of the mold base 24 may be the same as the covering material, typically the base and covering materials will be different materials from each other. Finally, at block 180, the top or exposed surface 44 of the covering layer 40 may be polished, treated or otherwise finished to provide a suitable molding surface 44 onto which production parts may be molded.

FIG. 2 shows a series of schematic sectional views illustrating successive steps in forming a mold 20 in accordance with the method 100. FIG. 2A illustrates step 110, in which a base portion 22 made of a base material is formed or provided. FIG. 2B illustrates step 120, in which an optional coating layer 26 made of a coating material is formed on the top surface 28 of the base portion 22, as well as step 130 in which the coating layer 26 may be cured. FIG. 2C illustrates step 140, in which the network 36_{N} of sacrificial components 36 is applied to the first surface 34 of the mold base 24. FIG. 2D illustrates step 150, in which the network 36_{N} of components 36 and the first surface 34 are covered with a layer 40 of covering material. Note that the sacrificial components 36 may cause respective bumps or protrusions 46 on the top surface 44 of the covering layer 40. Also note that the covering layer 40 completely covers the network 36_{N} so that no individual sacrificial components 36 are exposed. Step 160, in which the covering layer 40 is cured, may also be illustrated by FIG. 2D. FIG. 2E illustrates step 170, in which the sacrificial material is removed by deflagration, melting, dissolution or vaporization, thereby leaving a network 42_{N} of channels or passageways 42 disposed within the covering layer 40. And FIG. 2F illustrates step 180, in which the top surface 44 of the covering layer 40 is finished, such as by removing the protrusions 46 and polishing the resulting surface 44.

The resulting mold 20 features a plurality of channels 42 which may be disposed near the top surface 44 of the covering layer 40. These “near-surface” channels 42 may be used to circulate hot or cold fluids in order to heat or cool the mold 20, particularly near the surface 44 onto which production parts may be molded. In fact, a mold 20 may have multiple, separate networks 42_{N} of channels 42 formed therein, with one or more networks 42_{N} being used for heating certain areas of the mold 20, and one or more other networks 42_{N} being used for cooling other areas of the mold 20.

Each network 42_{N} of channels 42 is formed by first forming a corresponding network 36_{N} of sacrificial components 36 inside the covering layer 40. The web or network 36_{N} of components 36 is positioned within the covering layer 40 where it is desired for the network 42_{N} of channels 42 to be positioned. Then, the sacrificial material which makes up the components can be removed (by deflagration, etc.), leaving behind the desired network 42_{N} of channels 42, which can be used for thermal regulation of the mold 20.

FIG. 3 shows a series of schematic sectional views illustrating a series of steps for forming a mold 20 in accordance with the method 100, as an alternative to the sequence shown in FIG. 2. In particular, whereas the steps in FIG. 2 included a coating layer 26, the steps illustrated in FIG. 3 do not. (Therefore, FIG. 3 does not illustrate step 120 of forming a coating layer, nor step 130 of curing a coating layer.) Thus, in FIG. 3, the sacrificial components 36 are formed directly on the base portion 22. Also, whereas the configuration shown in FIG. 2 utilized sacrificial components 36 and channels 42 having circular cross-sections, the configuration shown in FIG. 3 utilizes rectangular cross-sections.

FIG. 3A illustrates step 110, in which a base portion 22 made of a base material is formed or provided. FIG. 3B illustrates step 140, in which the network 36_{N} of sacrificial components 36 is applied to the first surface 34 of the mold base 24 (i.e., to the top 28 of the base portion 22). FIG. 3C illustrates step 150, in which the network 36_{N} of components 36 and the first surface 34 are covered with a layer 40 of covering material. (Step 160, in which the covering layer 40 is cured, may also be illustrated by FIG. 3C.) FIG. 3D illustrates step 170, in which the sacrificial material is removed by deflagration, melting, dissolution or vaporization, thereby leaving a network 42_{N} of channels or passageways 42 disposed within the covering layer 40. And FIG. 3E illustrates step 180, in which the top surface 44 of the covering layer 40 is finished, such as by removing the protrusions 46 and polishing the resulting surface 44.

Similarly, FIG. 4 shows yet another alternative series of steps for forming a mold 20 in accordance with the method 100. The sequence illustrated in FIG. 4 is similar to the sequence illustrated in FIG. 2, but with the configuration in FIG. 4 including a network 48_{N} of furrows 48. FIG. 4A illustrates step 110, in which a base portion 22 made of a base material is formed or provided. FIG. 4B illustrates step 120, in which an optional coating layer 26 made of a coating material is formed on the top surface 28 of the base portion 22, as well as step 130 in which the coating layer 26 may be cured. Note that the top or free surface 32, 34 of the coating layer 26 has a network 48_{N} of furrows or troughs 48 formed therein. These furrows 48 are located where the sacrificial components 36 are desired to be placed. FIG. 4C illustrates step 140, in which the network 36_{N} of sacrificial components 36 is applied or placed within the network 48_{N} of furrows 48. FIG. 4D illustrates step 150, in which the network 36_{N} of components 36 and the first surface 34 are covered with a layer 40 of covering material. Step 160, in which the covering layer 40 is cured, may also be illustrated by FIG. 4D. And FIG. 4E illustrates step 170, in which the sacrificial material is removed by deflagration, melting, dissolution or vaporization, thereby leaving a network 42_{N} of channels or passageways 42 disposed within the covering layer 40. Note that no bumps or protrusions 46 are shown in the configuration of FIG. 4, so no illustration is provided for step 180, in which the top surface 44 of the covering layer 40 is finished. However, if any bumps 46 were present, or it were desired to polish or finish the molding surface 44, then step 180 could be performed.

In one embodiment, a method 100 of fabricating a mold 20 for producing a part includes: (i) applying a network 36_{N} of sacrificial components 36 onto a first surface 34 of a mold base 24, wherein the sacrificial components 36 are made of a sacrificial material (step 140); (ii) covering the network 36_{N} of sacrificial components 36 and the first surface 34 with a layer 40 of a covering material (step 150); and (iii) removing the sacrificial material to produce a network 42_{N} of channels 42 within the layer 40 of the covering material (step 170).

In another embodiment, a method 100 of fabricating a mold 20 includes: (i) forming a coating layer 26 made of a coating material on a base portion 22 made of a base material to form a mold base 24, wherein the coating layer 26 has an interfacial surface 30 in conformal contact with the base portion 22 and a free surface 32 opposite the interfacial surface 30 (step 120); (ii) applying a network 36_{N} of sacrificial components 36 onto the free surface 32 of the coating layer 26, wherein the sacrificial components 36 are made of a sacrificial material (step 140); covering the network 36_{N} of sacrificial components 36 and the free surface 32 with a covering layer 40 made of a covering material (step 140); and (iv) removing the sacrificial material to produce a network 42_{N} of channels 42 within the covering layer 40 (step 170).

In another embodiment, a mold 20 for producing a part includes: a mold base 24 having a first surface 34; a layer 40 of a covering material covering the first surface 34; and a network 42_{N} of channels 42 disposed within the layer 40 of covering material and produced by: (i) forming a network 36_{N} of sacrificial components 36 within the layer 40 of covering material corresponding to the network 42_{N} of channels 42, wherein the sacrificial components 36 are made of a sacrificial material; and (ii) removing the sacrificial material.

FIG. 5 is a schematic sectional top view of a mold 20 with part of the covering layer 40 removed to show the network 42_{N} of interconnecting channels 42. Here, the channels 42 are configured as a dual-manifold network 42_{N}, with one end of the channels 42 in fluid communication with an inlet manifold 50 (having an inlet port 52) and the other end of the channels 42 in fluid communication with an outlet manifold 54 (having an outlet port 56). This configuration allows coolant to be circulated from the inlet port 52 to the outlet port 56, thus providing cooling via the channels 42 throughout the mold 20.

FIG. 6 shows a schematic sectional elevation view of the mold 20 as viewed along section 6-6 of FIG. 5. Here, the inlet port 52 area includes an interior chamber 58 defined by a top wall or ceiling 60 and a bottom wall or floor 62, and a built-up or raised area 64 immediately surrounding the inlet port 52. The network 42_{N} may include enlarged sections 66 of selected channels 421 where more cooling is needed in the adjacent mold area, as well as cross-members 68 between or among adjacent channels 42. Although the channels 42 shown appear to be of the same overall width, they may also be of varying widths and diameters, as well as varying cross-sectional shapes.

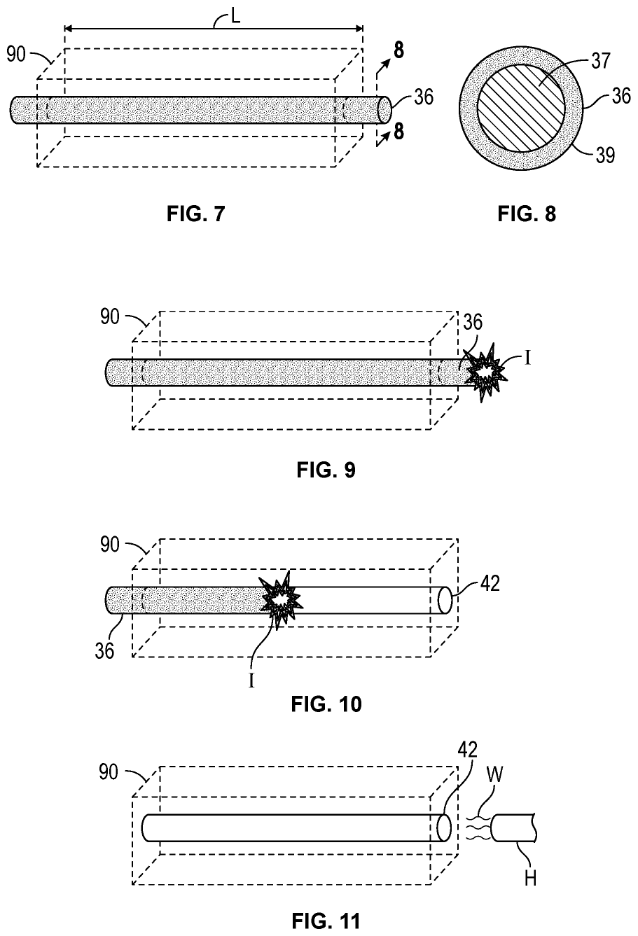

The process of forming the network 42_{N} of channels 42 will now be discussed in more detail. With reference to FIG. 7, the present disclosure describes a method of forming channels 42 within or on a substrate 90 using deflagration of sacrificial components 36 made of a sacrificial material. Depending on the mold configuration, and whether the sacrificial components 36 are formed within the substrate 90 or on the substrate 90, the substrate 90 may be the mold base 24 (see FIG. 3, where the components 36 are formed on the top surface 28 of the mold base 24), the coating layer 26 (see FIG. 2, where the components 36 are formed on the top or free surface 32 of the coating layer 26, as well as FIG. 4, where the components 36 are formed within the furrows 48 of the coating layer 26), the covering layer 40 (see FIG. 2, where the components 36 are formed within the covering layer 40), or both the coating and covering layers 26, 40 together (such as when these layers 26, 40 are made of the same material, or even different materials). In this method, a sacrificial component 36 may be molded directly into/onto the substrate 90 as shown in FIG. 7. For example, the sacrificial component 36 may be formed directly into/onto the substrate 90 such that the sacrificial component 36 is disposed inside of or on a surface of the substrate 90. For instance, after formation, a majority of the sacrificial components 36 may be entirely disposed inside the substrate 90 to facilitate the formation of channels 42. However, at least part of one or more sacrificial components 36 should be disposed outside of the substrate 90 to allow it to be ignited as discussed below.

With reference to FIG. 8, the sacrificial component 36 may include a combustible core 37 and an optional protective shell 39 surrounding the combustible core 37. The combustible core 37 allows for rapid deflagration but not detonation. The heat generated during deflagration is dissipated rapidly enough to prevent damage to the substrate 90. After deflagration, the combustible core 37 may generate easy-to-remove byproducts, such as fine powdered and large gaseous components. It is contemplated that the combustible core 37 may be self-oxidizing to burn in a small diameter along long channels. The combustible core 37 may also be resistant to molding pressures. Further, the combustible core 37 may be shelf stable and stable during manufacturing (i.e., the flash point is greater than the manufacturing or processing temperature). The term “flash point” means the lowest temperature at which vapors of a combustible material will ignite, when given an ignition source. The sacrificial component 36 may be formed onto or within the substrate 90 at a processing temperature that is less than the flash point of the combustible material to avoid deflagration during the manufacturing process. The term “processing temperature” means a temperature required to perform a manufacturing operation, such as molding or casting. For example, the processing temperature may be the melting temperature of the material forming the substrate 90 (i.e., the melting temperature of the polymeric resin forming the substrate 90). The combustible core 37 is wholly or partly made of a combustible material. To achieve the desired properties mentioned above, the combustible material may be black powder (i.e., a mixture of sulfur, charcoal, and potassium nitrate). To achieve the desired properties mentioned above, the combustible material may alternatively or additionally be pentaerythritol tetranitrate, combustible metals, combustible oxides, thermites, nitrocellulose, pyrocellulose, flash powders, and/or smokeless powder. Non-combustible materials could be added to the combustible core 37 to tune combustion speed and heat generation. To tune speed and heat generation, suitable non-combustible materials for the combustible core 37 include, but are not limited to, glass beads, glass bubbles, and/or polymer particles.

The optional protective shell 39 may be made of a protective material, which may be non-soluble material in combustible resin (e.g., epoxy, polyurethane, polyester, among others) in order to be shelf stable and stable during manufacturing. Also, this protective material may be impermeable to resin and moisture. The protective material may have sufficient structural stability to be integrated into a fiber textiling and preforming process. The protective material may have sufficient strength and flexibility to survive the fiber preform process. To achieve the desirable properties mentioned above, the protective material may include, for example, braided fibrous material, such as glass fiber, aramid fiber, carbon fiber, and/or natural fiber, infused with an infusion material such as a polymer or wax, oil, a combination thereof or similar material. To achieve the desirable properties mentioned above, the infused polymer may be, for example, polyimide, polytetrafluoroethylene (PTFE), high-density polyethylene (HDPE), polyphenylene sulfide (PPS), polyphthalamide (PPA), polyamides (PA), polypropylene, nitrocellulose, phenolic, polyester, epoxy, polylactic acid, bismaleimides, silicone, acrylonitrile butadiene styrene, polyethylene, polycarbonate, elastomers, polyurethane, polyvinylidene chloride (PVDC), polyvinyl chloride (PVC), polystyrene (PS) a combination thereof, or any other suitable plastic. Suitable elastomers include, but are not limited to, natural polyisoprene, synthetic polyisoprene, polybutadiene (BR), chloroprene rubber (CR), butyl rubber, styrene-butadiene rubber, nitrile rubber, ethylene propylene rubber, epichlorohydrin rubber (ECO), polyacrylic rubber, fluorosilicone rubber, perfluoroelastomers, polyether block amides, chlorosulfonated polyethylene, ethylene-vinyl acetate, shellac resin, nitrocellulose lacquer, epoxy resin, alkyd, polyurethane, etc.

With reference to FIG. 9, after molding the sacrificial component 36 onto or within the substrate 90, the sacrificial component 36 is ignited. To do so, a flame may be placed in direct contact with the sacrificial component 36 to cause an ignition I. A lighter or any device capable of producing a flame can be used to ignite the sacrificial component 36.

With reference to FIG. 10, the ignition I causes deflagration of the sacrificial component 36. Deflagration converts the solid sacrificial material into gaseous and fine powder byproducts. As a consequence, a channel 42 is formed in/on the substrate 90. The sacrificial component 36 may be cylindrical in order to form the channel 42 with a cylindrical shape. The sacrificial component 36 may alternatively have other shapes, such as triangular, elliptical, rectangular, etc. Further, before ignition I, the sacrificial component 36 may extend through the entire length L (FIG. 7) of the substrate 90 or substrate perimeter such that, after deflagration, the channel 42 extends through the entire length L (FIG. 7) of the substrate 90.

With reference to FIG. 11, after deflagration, the channel 42 may optionally be cleaned to remove byproducts of the deflagration of the sacrificial component 36. To do so, a liquid W, such as water, may be introduced into the channel 42 of the substrate 90 to remove byproducts of the deflagration of the sacrificial component 36. A hose H may be used to introduce the liquid W into the channel 42. A gas, such as air, may alternatively or additionally may be shot into the channel 42 to remove byproducts of the deflagration of the sacrificial component 36. Or, the channel 42 may not need any cleaning of byproducts.

Note that while FIGS. 7-14 show one or more sacrificial components 36 and channels 42 disposed within the substrate 90, the same approach applies for configurations where the sacrificial components 36 and channels 42 are disposed on the surface of a substrate 90. For example, see FIG. 3, where the components 36 are formed on the top surface 28 of the base portion 22 or mold base 24. These sacrificial components 36 are then covered with a layer 40 of covering material, as discussed above.

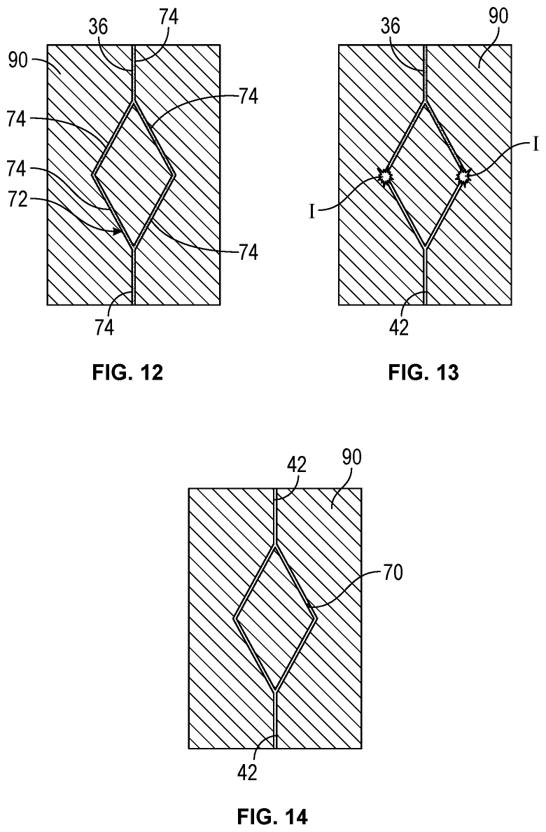

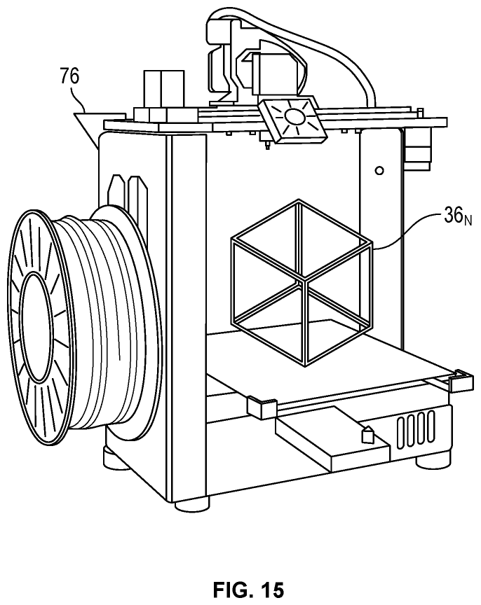

With reference to FIGS. 12-14, the method described above can be used to provide the substrate 90 with a branched channel-network 70 (FIG. 14). Accordingly, the method shown in FIGS. 12-14 is substantially similar to the method described above with respect to FIGS. 7-11, except for the differences described below. In this method, the sacrificial component 36 is also molded directly into/onto the substrate 90, but the sacrificial component 36 is configured as a branched network 72 of sacrificial components 36 including filaments 74 which may intersect each other or otherwise branch off from one another. After molding the sacrificial component 36 into/onto the substrate 90, the sacrificial component 36 is ignited as described above to cause deflagration of the sacrificial component 36 as shown in FIG. 13, thereby producing the substrate 90 with the branched channel-network 70 (i.e., a localized network of branched channels 42 or filaments 74) as shown in FIG. 14.

With reference to FIG. 15, any of the methods described herein may further include forming the network 36_{N} of sacrificial components 36 using an additive manufacturing process to allow the formation of the network 36_{N} with complex shapes. In the present disclosure, the term “additive manufacturing process” means a process in which a 3D object is built by adding layer-upon-layer of material. 3D printing process is a kind of additive manufacturing process. In the present disclosure, the term “3D printing process” means a process in which a 3D Computer Aided Design (CAD) model is read by a computer, and the computer commands the 3D printer 76 to add successive layers of material to create a 3D object that corresponds to the 3D CAD model. The method 100 may use a 3D printing process (by employing the 3D printer 76) to create the network 36_{N} of sacrificial components 36 with complex shapes. In this method, the sacrificial components 36 can be wholly or partly made, for example, of black powder and/or the rocket propellant known as Rocket Candy. The 3D printer 76 may be used to additively build up the network 36_{N} of sacrificial components 36 layer-upon-layer on the substrate 90, or to construct one or more webs or networks 36_{N} of interconnected components 36 as one or more separate preforms (i.e., separate from the substrate 90). Note that the 3D printer 76 may be configured to selectably deposit multiple different materials on-the-fly, such as one material for the combustible core 37 and another material for the protective shell 39.

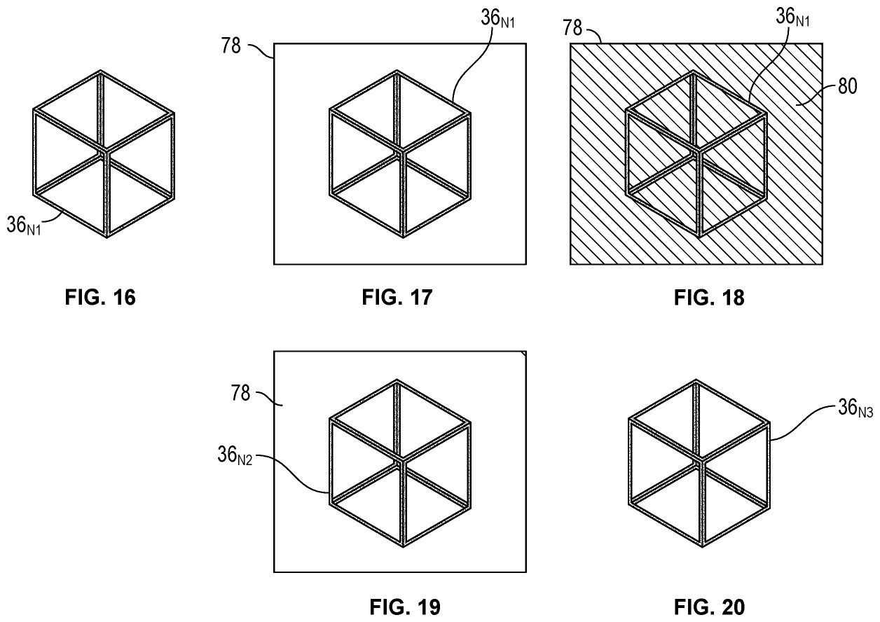

With reference to FIGS. 16-20, the method 100 described herein may entail first forming the network 36_{N} of sacrificial components 36 as an initial preform 36_{N} made of combustible material, as shown in FIG. 16. Then, the preform 36_{N1} may be placed inside a container 78 as shown in FIG. 17. Next, a liquid material 80 selected to provide a protective coating or shell 39 to the preform 36_{N1} is poured into the container 78 as shown in FIG. 18. Then, the liquid coating material 80 is removed from the container 78, leaving a wet or uncured preform 36_{N2} coated with the coating material 80, as shown in FIG. 19. While in the container 78, heat and/or accelerants may be used to dry or cure the coated preform 36_{N2}, resulting in the finished preform 36_{N3} shown in FIG. 20. The finished preform 36_{N3} may then be manually or robotically placed (i.e., mechanically placed) on the appropriate surface or substrate, and then covered with a covering layer 40 as described above. Note that instead of placing the initial preform 36_{N1} inside a container 78 and pouring in the protective coating material 80, the preform 36_{N1} may be dipped into a container 78 which contains the protective coating material 80, or the preform 36_{N1} may be sprayed with the material 80. Also, the coated preform 36_{N2} may not require any specialized drying or curing (and therefore no post-coating placement in a special container 78) as illustrated by FIG. 19, and may instead just be normally air-dried to provide the finished preform 36_{N3}.

Note that while the foregoing paragraphs describe the use of combustible core materials 37 and protective shell materials 39 for utilizing deflagration as the process for removing the sacrificial material to create the network 42_{N} of channels 42, similar approaches may be used (with appropriate materials and process steps) for melting, dissolving and vaporizing or depolymerizing the sacrificial material in order to create the resulting network 42_{N}.

The above description is intended to be illustrative, and not restrictive. In the above description and in the following claims, use of the terms “first”, “second”, “top”, “bottom”, etc. are used merely as labels, and are not intended to impose numerical or positional requirements on their objects. Additionally, the phrase “at least one of A and B” and the phrase “A and/or B” should each be understood to mean “only A, only B, or both A and B”. This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A method of fabricating a mold for producing a part, comprising:
applying a network of sacrificial components onto a first surface of a mold base, wherein the sacrificial components are made of a sacrificial material;
covering the network of sacrificial components and the first surface with a layer of a covering material; and
removing the sacrificial material to produce a network of channels within the layer of the covering material.

2. A method according to claim 1, further comprising:
curing the layer of the covering material.

3. A method according to claim 1, wherein the removing step is performed by deflagration of the sacrificial material.

4. A method according to claim 1, wherein the removing step is performed by one of melting, dissolution and vaporization of the sacrificial material.

5. A method according to claim 1, wherein the mold base is made of a base material that is different from the covering material.

6. A method according to claim 1, wherein the applying step is performed by one of:
building up the network of sacrificial components on the first surface of the mold base by additive manufacturing; and
placing the network of sacrificial components onto the first surface of the mold base, wherein the network of sacrificial components is preformed.

7. A method according to claim 1, further comprising:
forming a layer of a coating material on a base portion made of a base material to form the mold base, wherein the layer of coating material has a free surface serving as the first surface of the mold base.

8. A method according to claim 7, further comprising:
curing the layer of coating material.

9. A method according to claim 7, wherein the free surface includes a network of furrows formed therein, and wherein the network of sacrificial components is applied within the network of furrows.

10. A method according to claim 7, wherein the covering material and the coating material are the same.

11. A method of fabricating a mold, comprising:
forming a coating layer made of a coating material on a base portion made of a base material to form a mold base, wherein the coating layer has an interfacial surface in conformal contact with the base portion and a free surface opposite the interfacial surface;
applying a network of sacrificial components onto the free surface of the coating layer, wherein the sacrificial components are made of a sacrificial material;
covering the network of sacrificial components and the free surface with a covering layer made of a covering material; and
removing the sacrificial material to produce a network of channels within the covering layer.

12. A method according to claim 11, wherein the removing step is performed by one of deflagration, melting, dissolution and vaporization of the sacrificial material.

13. A method according to claim 11, further comprising at least one of:
curing the coating layer; and
curing the covering later.

14. A method according to claim 11, wherein the free surface includes a network of furrows formed therein, and wherein the network of sacrificial components is applied within the network of furrows.

15. A method according to claim 11, wherein the applying step is performed by one of:
building up the network of sacrificial components on the free surface of the coating layer by additive manufacturing; and
placing the network of sacrificial components onto the free surface of the coating layer, wherein the network of sacrificial components is preformed.

16. A mold for producing a part, comprising:
a mold base having a first surface;
a layer of a covering material covering the first surface; and
a network of channels disposed within the layer of covering material and produced by:
forming a network of sacrificial components within the layer of covering material corresponding to the network of channels, wherein the sacrificial components are made of a sacrificial material; and
removing the sacrificial material.

17. A mold according to claim 16, wherein the sacrificial material is removed by deflagration.

18. A mold according to claim 16, wherein the sacrificial material is removed by one of melting, dissolution and vaporization of the sacrificial material.

19. A mold according to claim 16, further comprising a layer of a coating material interposed between the mold base and the layer of covering material.

20. A mold according to claim 16, wherein the network of sacrificial components is formed by one of:
additive manufacturing; and
mechanical placement, wherein the network of sacrificial components is preformed.
